(19) United States
(12) Patent Application Publication
(10) Pub. No.: US 2026/0280040 A1
(43) Pub. Date: Sep. 17, 2026

(54) ENERGY STORAGE SYSTEM AND BATTERY MODULE

(71) Applicant: SAMSUNG SDI CO., LTD., Yongin-si (KR)

(72) Inventors: No Hyun KWAG, Suwon-si (KR); In Bo SHIM, Suwon-si (KR)

(21) Appl. No.: 19/395,084

(22) Filed: Nov. 20, 2025

(30) Foreign Application Priority Data
Mar. 11, 2025 (KR) 10-2025-0031431

(51) Int. Cl. H01M 50/383; H01M 10/42; H01M 10/48; H01M 10/658; H01M 50/284; H01M 50/519

(52) U.S. Cl. CPC H01M 50/383; H01M 10/4257; H01M 10/482; H01M 10/486; H01M 10/658; H01M 50/284; H01M 50/519; H01M 2010/4271; H01M 2200/10

(57) ABSTRACT

An energy storage system, including a battery module including a plurality of battery cells, a battery rack configured to support the battery module, a module fire extinguishing unit configured to detect whether a fire has occurred in the battery module and spray a fire extinguishing agent onto the battery module if fire is detected, a control unit connected to the plurality of battery cells, the control unit being configured to detect a state of one or more of the plurality of battery cells, and a heat blocking unit in the control unit and configured to prevent damage to at least one of the plurality of battery cells due to heat.

### CROSS-REFERENCE TO RELATED APPLICATION

This application claims priority from and the benefit under 35 USC § 119 of Korean Patent Application No. 10-2025-0031431, filed on Mar. 11, 2025, in the Korean Intellectual Property Office, the entire disclosure of which is incorporated by reference for all purposes.

### BACKGROUND

### 1. Field

The present disclosure relates to an energy storage system and a battery module.

### 2. Description of the Related Art

In general, an energy storage system (ESS) (or an energy storage device) is a system capable of storing surplus electricity or electricity produced using renewable energy. By using an ESS, surplus power is stored during a time for which electricity demand is low, and electricity is supplied during a time for which electricity demand is high, thereby smoothly controlling power supply.

A space or facility in which an ESS is installed and operated should be mandatorily equipped with equipment for suppressing battery fires caused by electric shocks, short circuits, external surges, or the like. A typical fire extinguishing system includes a fire detection sensor, a sprinkler or a fire extinguishing agent sprayer installed around a battery rack or on a ceiling, and the like.

The above-described information disclosed in the background technology of the present disclosure is only for improving understanding of the background of the present disclosure, and accordingly, can include information that does not constitute the related art.

### SUMMARY

Embodiments include an energy storage system, including a battery module including a plurality of battery cells, a battery rack configured to support the battery module, a module fire extinguishing unit configured to detect whether a fire has occurred in the battery module and spray a fire extinguishing agent onto the battery module if fire is detected, a control unit connected to the plurality of battery cells, the control unit being configured to detect a state of one or more of the plurality of battery cells, and a heat blocking unit in the control unit and configured to prevent damage to at least one of the plurality of battery cells due to heat.

The module fire extinguishing unit may include a module detection unit configured to detect at least one of a temperature change and a size change of the battery module, and a module spray unit configured to spray the fire extinguishing agent onto the battery module according to a detection signal of the module detection unit.

The module detection unit may include at least one of a temperature sensor configured to detect a temperature of the battery module, and a size sensor configured to detect a size of the battery module.

The temperature sensor may measure a temperature of each of the plurality of battery cells in the battery module.

The size sensor may be on the battery rack, the size sensor photographing the size of the battery module.

The energy storage system may further include a housing including the battery rack, wherein the size sensor is on the housing, the size sensor photographing the size of the battery rack.

The module spray unit may include a fire extinguishing tank in which the fire extinguishing agent is stored, a fire extinguishing pipe connected to the fire extinguishing tank, the fire extinguishing pipe being configured to guide the fire extinguishing agent, and a fire extinguishing nozzle on the fire extinguishing pipe, the fire extinguishing nozzle being configured to spray the fire extinguishing agent onto the battery module.

The control unit may include an insulating plate in the battery module, a busbar on the insulating plate, the busbar being connected to the plurality of battery cells, a wire harness on the insulating plate, the wire harness being connected to the busbar to transmit a signal, and a control board connected to the wire harness, the control board being configured to control the plurality of battery cells.

The heat blocking unit may be on the insulating plate, the heat blocking unit being between the plurality of battery cells and the wire harness to prevent heat generated in the plurality of battery cells from reaching the wire harness.

The heat blocking unit may be in the insulating plate.

A heat blocking unit may be integral with the insulating plate.

The heat blocking unit may be attached to the insulating plate.

The heat blocking unit may be between the insulating plate and the wire harness.

The heat blocking unit may include insulating substrates, and the insulating substrates may each be made of at least one of mica, fiber, sericite, talc, diatomaceous earth, bentonite, silicon, elvan, kaolin, polyimide, and polyethylene terephthalate.

The heat blocking unit may include two insulating substrates of the insulating substrates, and an insulating layer between the two insulating substrates, the insulating layer including an insulating material.

The insulating material may be at least one of aerogel, wet silica, dry silica, polyurethane, polystyrene, polyethylene, and polyester.

Embodiments include a battery module, including a case having a plurality of battery cells therein, a control unit connected to the plurality of battery cells, the control unit being configured to detect a state of one or more of the plurality of battery cells, and a heat blocking unit in the control unit, the heat blocking unit being configured to prevent damage to the plurality of battery cells due to heat.

The control unit may include an insulating plate in the case, a busbar on the insulating plate, the busbar being connected to the plurality of battery cells, a wire harness on the insulating plate, the wire harness being connected to the busbar to transmit a signal, and a control board connected to the wire harness, the control board being configured to control the plurality of battery cells.

The heat blocking unit may be in the insulating plate, the heat blocking unit being between the plurality of battery cells and the wire harness to prevent heat generated in the plurality of battery cells from reaching the wire harness.

The heat blocking unit may be attached to the insulating plate, the heat blocking unit being between the insulating plate and the wire harness to prevent heat generated in the plurality of battery cells from reaching the wire harness.

### BRIEF DESCRIPTION OF THE DRAWINGS

Features will become apparent to those of ordinary skill in the art by describing in detail exemplary embodiments with reference to the attached drawings, in which:

FIG. 1 is a schematic view illustrating an energy storage system according to one or more embodiments of the present disclosure;

FIG. 2 is a schematic view illustrating a battery rack according to one or more embodiments of the present disclosure;

FIG. 3 is a schematic view illustrating a state in which a module detection unit according to one or more embodiments of the present disclosure detects a temperature;

FIG. 4 is a schematic view illustrating a state in which the module detection unit according to one or more embodiments of the present disclosure detects a size or position;

FIG. 5 is a schematic view illustrating a module spray unit according to one or more embodiments of the present disclosure;

FIG. 6 is a schematic view illustrating a control unit according to one or more embodiments of the present disclosure;

FIG. 7 is a schematic view illustrating a state in which a heat blocking unit according to one or more embodiments of the present disclosure is embedded in an insulating plate;

FIG. 8 is a schematic view illustrating a state in which the heat blocking unit according to one or more embodiments of the present disclosure is attached to an upper surface of the insulating plate;

FIG. 9 is a schematic view illustrating a state in which the heat blocking unit according to one or more embodiments of the present disclosure is attached to a lower surface of the insulating plate;

FIG. 10 is a schematic view illustrating a state in which the heat blocking unit according to one or more embodiments of the present disclosure is attached to each of the upper surface and the lower surface of the insulating plate;

FIG. 11 is a schematic view illustrating a battery module according to another embodiment of the present disclosure;

FIG. 12 is a plan view illustrating a control unit according to another embodiment of the present disclosure;

FIG. 13 is a schematic view illustrating a state in which a heat blocking unit according to another embodiment of the present disclosure is embedded in an insulating plate;

FIG. 14 is a schematic view illustrating a state in which the heat blocking unit according to another embodiment of the present disclosure is attached to an upper surface of the insulating plate; and

FIG. 15 is a schematic view illustrating a state in which the heat blocking unit according to another embodiment of the present disclosure is embedded in the insulating plate and attached to the upper surface of the insulating plate.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Further, when used in the present specification, “comprise” or “include” and/or “comprising” or “including” specify the presence of mentioned shapes, numbers, steps, operations, members, elements and/or groups thereof, and do not exclude the presence or addition of one or more other shapes, numbers, steps, operations, members, elements and/or groups thereof.

The mention that two objects to be compared are ‘the same’ means that that the two objects are ‘substantially the same.’ Accordingly, ‘substantially the same’ may include a deviation considered as a low level in the art, for example, a deviation within 5%. Further, uniformity of a parameter in a certain region may mean uniformity from an average point of view.

Although first, second, and the like are used to describe various components, it goes without saying that these components are not limited by these terms. These terms are only used to distinguish one component from another component, and unless otherwise stated, it goes without saying that the first component may be the second component.

Throughout the specification, unless otherwise stated, each component may be singular or plural.

The placement of an arbitrary component on the "upper portion (or lower portion)” of a component or "above (or below)" of a component may mean not only that the arbitrary component is disposed in contact with an upper surface (or a lower surface) of the component, but also that another component may be interposed between the component and the arbitrary component disposed above (or below) the component.

Further, when it is disclosed that a certain component is “on,” “connected to,” or “coupled to” another component, it should be understood that the components may be directly connected or coupled to each other, but another component may be “interposed” between the components, or the components may be “connected,” “coupled,” or “linked” through another component.

As used in the present specification, the term "and/or" includes any one or more and all combinations of the related listed items. Further, when embodiments of the present disclosure are described, the use of “may” relates to ”one or more embodiments of the present disclosure.” The term such as “one or more” before a list of elements modifies an entire list of the elements and does not modify individual elements in the list.

Throughout the specification, “A and/or B” means to A, B, or A and B unless otherwise stated, and “C to D” means greater than or equal to C and less than or equal to D unless otherwise specified.

When phrases such as “at least one of A, B, and C,” “at least one of A, B, or C,” “at least one selected from group A, B, and C,” or “at least one selected from A, B, and C” are used to specify a list of elements A, B, and C, the phrases may refer to any one of all suitable combinations.

The term “use” may be considered to be synonymous with the term “utilize.” As used in the present specification, the terms “substantially,” “about,” and other similar terms are used as terms of approximation rather than terms of degrees, and are intended to consider an inherent variation in measured or calculated values to be recognized by those skilled in the art.

Although the terms “first,” “second,” “third,” and the like may be used in the present specification to describe various elements, components, regions, layers and/or sections, these elements, components, regions, layers and/or sections should not be limited by these terms. These terms are used only to distinguish one element, component, region, drawing layer, or section from another element, component, region, drawing layer, or section. Accordingly, a first element, component, region, layer, or section to be described below may be referred to a second element, component, region, layer, or section without departing from the teachings of the present disclosure.

Spatially related terms such as “beneath,” “below,” “lower,” “above,” and “upper” are used for easy description of the relationship of one element or feature to another element or feature shown in the drawings. These spatially related terms are provided for easy understanding of the present disclosure according to various process states or usage states of the present disclosure, and are not intended to limit the present disclosure. For example, when the elements or features in the drawings are reversed, an element described as “lower” or “below” “becomes “upper” or “above." Accordingly, “below” is a concept encompassing “above” or “below.”

The terms used in the present specification is intended to describe the embodiments of the present disclosure, and is not intended to limit the present disclosure.

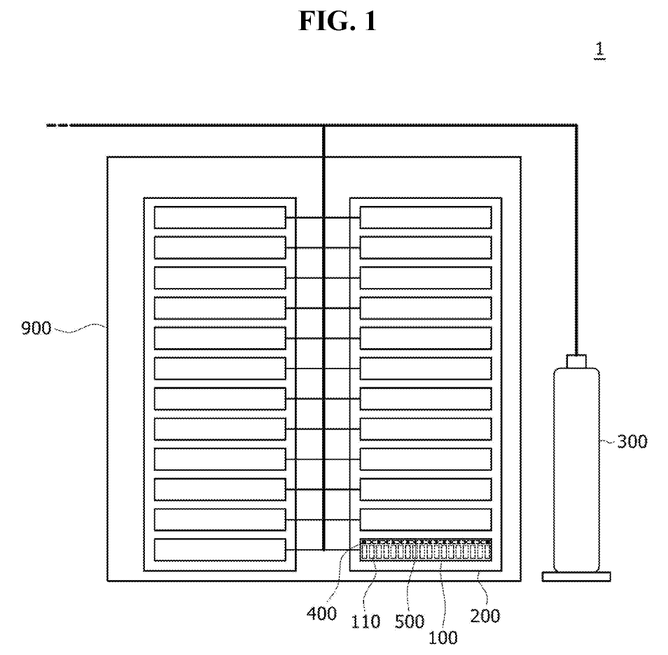

FIG. 1 is a schematic view illustrating a fire extinguishing device for an energy storage system according to one or more embodiments of the present disclosure. Referring to FIG. 1, an energy storage system 1 according to one or more embodiments of the present disclosure includes a battery module 100, a battery rack 200, a module fire extinguishing unit 300, a control unit 400, and a heat blocking unit 500.

The battery module 100 may include a plurality of battery cells 110. In the battery module 100, the plurality of battery cells 110 may each be accommodated inside a case having an approximately hexahedral shape. The battery cells 110 may be disposed to be spaced a certain interval apart from each other. The plurality of battery cells 110 may be disposed in a line to correspond to a size of the battery module 100. The plurality of battery cells 110 may include a secondary battery that can be charged and discharged.

The battery rack 200 may support the battery module 100. The battery rack 200 may be made of a metal material, and a flame retardant sheet may be attached thereto as needed. The battery rack 200 may have an approximately rectangular parallelepiped shape.

The module fire extinguishing unit 300 may detect whether a fire has occurred in the battery module 100 and may spray a fire extinguishing agent onto the battery module 100. The fire extinguishing agent may include at least one selected from argon, nitrogen, and carbon dioxide. When carbon dioxide is used as a fire extinguishing agent, carbon dioxide may be liquefied and stored at a low temperature and high pressure state.

The control unit 400 may be connected to the plurality of battery cells 110 to detect a state of the plurality of battery cells 110. The control unit 400 may manage each battery module 100 and each of the plurality of battery cells 110 embedded in the battery module 100.

The control unit 400 may include a lower control unit and an upper control unit. The lower control unit may be embedded in each battery module 100 and individually connected to the plurality of battery cells 110. The upper control unit may be connected to each lower control unit. In addition, each battery module 100 may be directly connected to the upper control unit. The control unit 400 may include a detection device, a balancing device, and a control device.

The detection device may detect a state (voltage, current, temperature, or the like) of the plurality of battery cells 110 and detect state information indicating the state of the plurality of battery cells 110. The detection device may detect a voltage for each of the plurality of battery cells 110 constituting the battery module 100. The detection device may also detect a current for each of the plurality of battery cells 110 constituting the battery module 100. The detection device may also detect the plurality of battery cells 110 or an ambient temperature at at least one point of the battery module 100.

The balancing device may perform a balancing operation of the battery cells 110 constituting the battery module 100.

The control device of the control unit 400 may receive state information (voltage, current, temperature, or the like) of the plurality of battery cells 110 from the detection device. The control device may monitor and calculate a state (voltage, current, temperature, state of charge (SOC), state of health (SOH), or the like) of the plurality of battery cells 110 based on the state information received from the detection device. In addition, the control device may perform a control function (for example, a temperature control, balancing control, or charge/discharge control function), a protection function (for example, an over-discharge, over-charge, or over-current prevention, short-circuit, or fire extinguishing function) based on state monitoring results. In addition, the control device may perform a wired or wireless communication function with an external device (for example, an upper controller, a vehicle, a charger, or a power conditioning system (PCS)) of the battery module 100. The control device may also control a charging/discharging operation and a protection operation of a battery.

The detection device, the balancing device, and the control device of the control unit 400 may each include a processor and a memory.

The processor may be implemented as a central processing unit (CPU) or a system-on-chip (SoC), may drive an operating system or application to control a plurality of hardware or software components connected to the processor, and may process various pieces of data and perform calculations. The processor may be configured to execute at least one instruction stored in the memory and store execution result data in the memory.

The memory may store at least one instruction executed by the processor. The memory may be implemented as a volatile storage medium and/or a non-volatile storage medium, for example, as a read-only memory (ROM) and/or a random access memory (RAM).

The heat blocking unit 500 may be provided in the control unit 400 and may prevent damage to the plurality of battery cells 110 due to heat. The heat blocking unit 500 may be formed integrally with (e.g., may be a monolithic and seamless structure with) the control unit 400 or attached to the control unit 400. The heat blocking unit 500 may include an insulating material to block heat of the plurality of battery cells 110 from reaching components of the control unit 400.

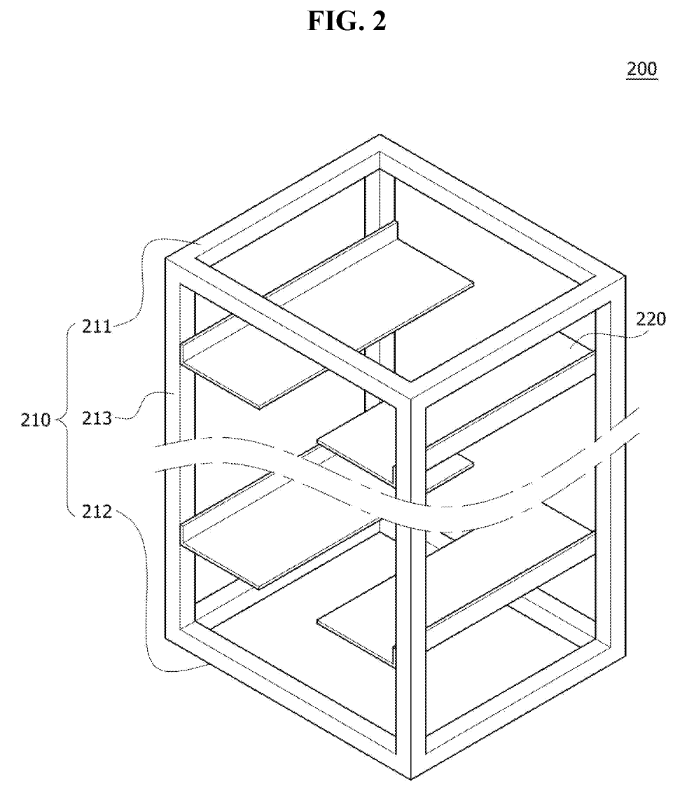

FIG. 2 is a schematic view illustrating the battery rack according to one or more embodiments of the present disclosure. Referring to FIG. 2, the battery rack 200 according to one or more embodiments of the present disclosure may include a rack frame 210 and a rack support 220.

The module fire extinguishing unit 300 and the control unit 400 may be optionally disposed on the rack frame 210. The rack frame 210 may form a framework with a rectangular parallelepiped shape. The rack frame 210 may include an upper frame 211, a lower frame 212 positioned below the upper frame 211, and a connection frame 213 connecting the upper frame 211 and the lower frame 212.

The rack support 220 may be formed on the rack frame 210 and may support the battery module 100. A plurality of rack supports 220 may be disposed to be spaced apart from each other in a vertical length direction of the connection frame 213, and a pair of rack supports 220 may be disposed to face each other at the same level to vertically support a plurality of battery modules 100.

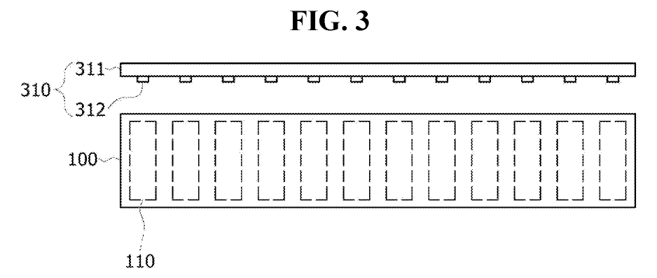

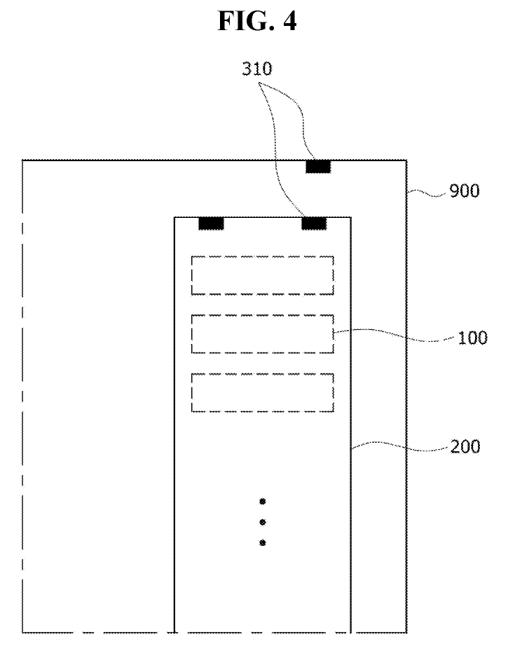

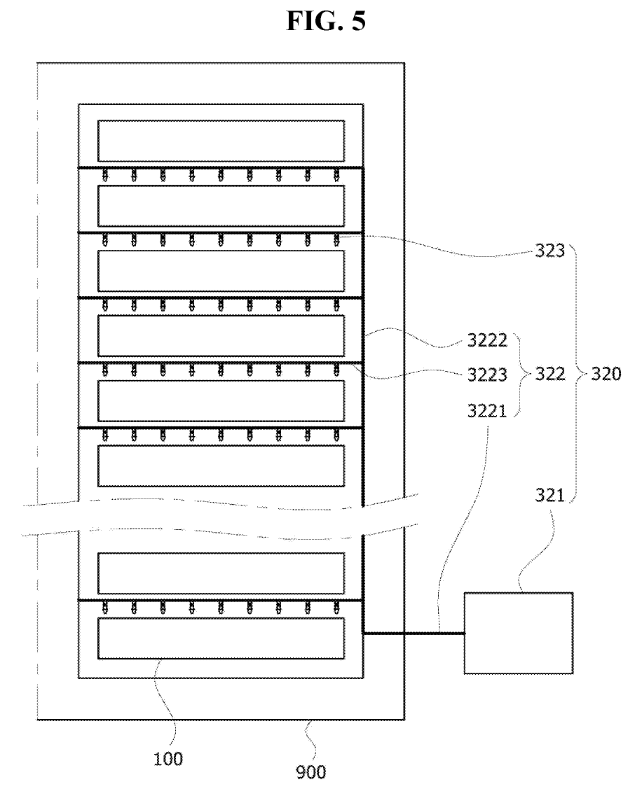

FIG. 3 is a schematic view illustrating a state in which a module detection unit according to one or more embodiments of the present disclosure detects a temperature. FIG. 4 is a schematic view illustrating a state in which the module detection unit according to one or more embodiments of the present disclosure detects a size or position. FIG. 5 is a schematic view illustrating a module spray unit according to one or more embodiments of the present disclosure. Referring to FIGS. 3 to 5, the module fire extinguishing unit 300 according to one or more embodiments of the present disclosure may include a module detection unit 310 and a module spray unit 320.

The module detection unit 310 may detect at least one of a temperature change and a size change of the battery module 100. The module detection unit 310 may be mounted on the battery rack 200 or an external housing 900 in which the battery rack 200 is embedded.

The module spray unit 320 may spray a fire extinguishing agent onto the battery module 100 according to a detection signal of the module detection unit 310. The entirety of the module spray unit 320 may be embedded in the external housing 900, or a portion thereof may be disposed outside the external housing 900. The fire extinguishing agent may include at least one of argon, nitrogen, and carbon dioxide. When carbon dioxide is used as an fire extinguishing agent, carbon dioxide may be liquefied and stored at a low temperature and high pressure state.

The module detection unit 310 according to one or more embodiments of the present disclosure may include at least one of a temperature sensor 311 and a size sensor 312.

The temperature sensor 311 may detect a temperature of the battery module 100. The temperature sensor 311 may measure a temperature of each battery module 100. The temperature sensor 311 may be mounted on the battery rack 200 and may detect a temperature by photographing the battery module 100. In addition, the temperature sensor 311 may measure a temperature of each of the plurality of battery cells 110.

The size sensor 312 may detect a size or position of the battery module 100. The size sensor 312 may be mounted on the battery rack 200 and may photograph a size of the battery module 100 to detect whether the battery module 100 has expanded. When a size of the battery module 100 expands to be greater than or equal to a size of the plurality of battery cells 110, the size sensor 312 may detect the size. The size sensor 312 may detect an outer surface position of the battery module 100.

When a size of the battery module 100 reaches a set size or a set position, the module spray unit 320 may receive a detection signal from the size sensor 312 to spray a fire extinguishing agent.

In addition, the size sensor 312 may be mounted on the external housing 900 in which the battery rack 200 is provided and may photograph a size of the battery rack 200 to detect whether the battery rack 200 has expanded. That is, when the battery module 100 is pressed against the battery rack 200 according to a design environment, the battery rack 200 itself may be deformed and expanded by being pushed by the battery module 100 when the battery module 100 intermittently expands. The size sensor 312 mounted on the external housing 900 may detect deformation of the battery rack 200. In addition, the size sensor 312 mounted on the external housing 900 may detect an outer surface position of the battery rack 200.

When a size of the battery rack 200 reaches a set size or a set position, the module spray unit 320 may receive a detection signal from the size sensor 312 to spray a fire extinguishing agent.

The module spray unit 320 according to one or more embodiments of the present disclosure may include a fire extinguishing tank 321, a fire extinguishing pipe 322, and a fire extinguishing nozzle 323.

A fire extinguishing agent may be stored in the fire extinguishing tank 321. The fire extinguishing tank 321 may be stored inside the external housing 900 or disposed outside the external housing 900.

The fire extinguishing pipe 322 may be connected to the fire extinguishing tank 321 to guide a fire extinguishing agent. The fire extinguishing pipe 322 may be mounted on the battery rack 200 and may be disposed above the battery module 100. The fire extinguishing pipe 322 may include a first pipe 3221, a second pipe 3222, and a third pipe 3223. The first pipe 3221 may be connected to the fire extinguishing tank 321. The second pipe 3222 extends from the first pipe 3221 and may be fixedly installed in the external housing 900 or the battery rack 200. The third pipe 3223 may be connected to the second pipe 3222 and may extend toward the plurality of battery modules 100 vertically arranged inside the battery rack 200. A plurality of third pipes 3223 may branch in a length direction of the second pipe 3222 and may each be disposed above the battery module 100.

The fire extinguishing nozzle 323 may be formed on the fire extinguishing pipe 322 and may spray a fire extinguishing agent onto the battery module 100. A plurality of fire extinguishing nozzles 323 may be disposed in a length direction of the third pipe 3223 to respond to fires of the battery module 100 occurring at various points.

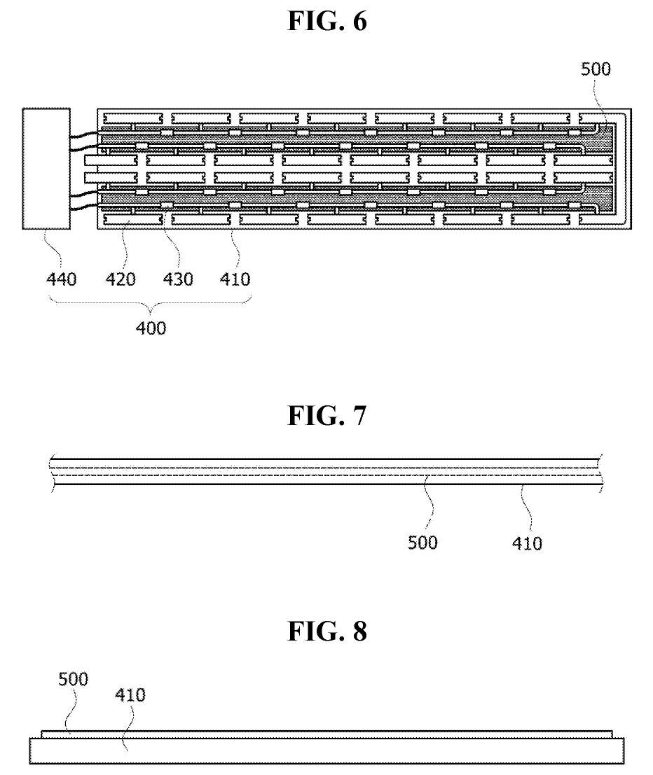

FIG. 6 is a schematic view illustrating the control unit according to one or more embodiments of the present disclosure. Referring to FIG. 6, the control unit 400 according to one or more embodiments of the present disclosure may include an insulating plate 410, a busbar 420, a wire harness 430, and a control board 440.

The insulating plate 410 may be embedded in the battery module 100. The insulating plate 410 may be molded by including an insulating material and a flame retardant material. Inside the battery module 100, the battery cells 110 may be disposed in a line, and the insulating plate 410 may be disposed above the battery cells 110. The insulating plate 410 may be mounted above the plurality of battery cells 110 or may be placed across an inner side of the battery module 100.

The insulating plate 410 may include at least one of PA6, polyimide (PI), polysulfone, polyurethane (PU), polyamide (PA), 6,6 nylon, polycarbonate (PC), polytetrafluoroethylene (PTFE), polymethyl methacrylate (PMMA), and polyethylene terephthalate (PET).

A plurality of busbars 420 may be mounted on the insulating plate 410 and may be connected to each of the plurality of battery cells 110. A lower portion of the busbar 420 may be connected to a terminal of the plurality of battery cells 110, and an upper portion of the busbar 420 may be exposed on the insulating plate 410. The busbar 420 may be coupled to the insulating plate 410 or may be exposed to the outside through a hole formed in the insulating plate 410.

The wire harness 430 may be mounted on the insulating plate 410 and connected to the busbar 420 to transmit a signal. The wire harness 430 may be disposed in a length direction of the insulating plate 410 and may include a plurality of cables connected to each busbar 420.

The control board 440 may be connected to the wire harness 430 and may control the plurality of battery cells 110. Components for controlling the plurality of battery cells 110 may be mounted on the control board 440. The control board 440 may be disposed outside the battery module 100 and connected to the wire harness 430 through a connector to transmit a signal. The control board 440 may be disposed on the insulating plate 410 as needed.

The heat blocking unit 500 according to one or more embodiments of the present disclosure may be formed on the insulating plate 410 and may be disposed between the plurality of battery cells 110 and the wire harness 430. The heat blocking unit 500 may prevent heat generated in the plurality of battery cells 110 from reaching the wire harness 430.

FIG. 7 is a schematic view illustrating a state in which the heat blocking unit according to one or more embodiments of the present disclosure is embedded in the insulating plate. Referring to FIG. 7, the heat blocking unit 500 according to a first embodiment may be embedded in the insulating plate 410.

The insulating plate 410 may be injection-molded using an insulating resin material, and the heat blocking unit 500 may be formed integrally with the insulating plate 410. In addition, a pair of insulating plates 410 may be assembled to face each other, and the heat blocking unit 500 may be disposed between the insulating plates 410.

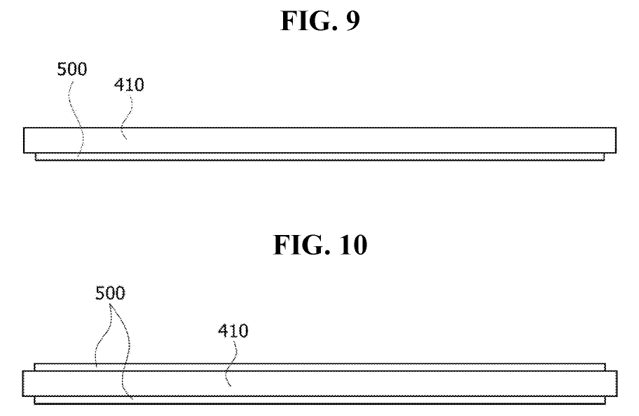

FIG. 8 is a schematic view illustrating a state in which the heat blocking unit according to one or more embodiments of the present disclosure is attached to an upper surface of the insulating plate. FIG. 9 is a schematic view illustrating a state in which the heat blocking unit according to one or more embodiments of the present disclosure is attached to a lower surface of the insulating plate. FIG. 10 is a schematic view illustrating a state in which the heat blocking unit according to one or more embodiments of the present disclosure is attached to each of the upper surface and the lower surface of the insulating plate. Referring to FIGS. 8 to 10, the heat blocking unit 500 according to a second embodiment may be attached to the insulating plate 410. The heat blocking unit 500 includes an insulating substrate, and the insulating substrate may include a tape layer.

The heat blocking unit 500 may be disposed between the insulating plate 410 and the wire harness 430. As a first example, the heat blocking unit 500 may also be attached to the upper surface of the insulating plate 410 to support the wire harness 430 (see FIG. 8). The heat blocking unit 500 may cover the wire harness 430. In one or more other embodiments, the heat blocking unit 500 may be attached to the lower surface of the insulating plate 410 (see FIG. 9). In still one or more other embodiments, the heat blocking unit 500 may be attached to each of the upper surface and the lower surface of the insulating plate 410 (see FIG. 10).

In addition, the heat blocking unit 500 may be not only embedded in the insulating plate 410, but also attached to the outside of the insulating plate 410 to improve insulation performance.

The heat blocking unit 500 according to one or more embodiments of the present disclosure may include an insulating substrate, and the insulating substrate may include at least one of mica, fiber, sericite, talc, diatomaceous earth, bentonite, silicon, elvan, kaolin, PI, and polyethylene terephthalate.

The heat blocking unit 500 according to one or more embodiments of the present disclosure may include two insulating substrates and an insulating layer positioned between the two insulating substrates and including an insulating material.

The two insulating substrates may include at least one of mica, talc, diatomaceous earth, bentonite, silicon, elvan, kaolin, PI, and polyethylene terephthalate, or a mixture of two or more thereof.

The insulating material may include at least one of aerogel, wet silica, dry silica, PU, polystyrene, polyethylene, and polyester, or a mixture of two or more thereof.

A fire extinguishing operation for the energy storage system 1 according to one or more embodiments of the present disclosure having such a structure will be described as follows.

The module detection unit 310 detects a state of the battery module 100 or the plurality of battery cells 110 embedded in the battery module 100. The module detection unit 310 may detect a size change or a temperature change of the battery module 100.

Based on data detected by the module detection unit 310, the module spray unit 320 may spray a fire extinguishing agent to prevent explosions or fires of the battery module 100.

Meanwhile, the insulating plate 410 is disposed on the plurality of battery cells 110, and the wire harness 430 is connected to the busbar 420 connected to the plurality of battery cells 110. The wire harness 430 is seated on the insulating plate 410, and the heat blocking unit 500 is formed on the insulating plate 410.

The heat blocking unit 500 may be embedded in the insulating plate 410 or optionally attached to an outer surface of the insulating plate 410. Since the heat blocking unit 500 is formed by including an insulating material, the heat blocking unit 500 can block heat from being transferred to the wire harness 430 even when the plurality of battery cells 110 is heated. The occurrence of secondary ignition of the wire harness 430 can be prevented by the heat blocking unit 500.

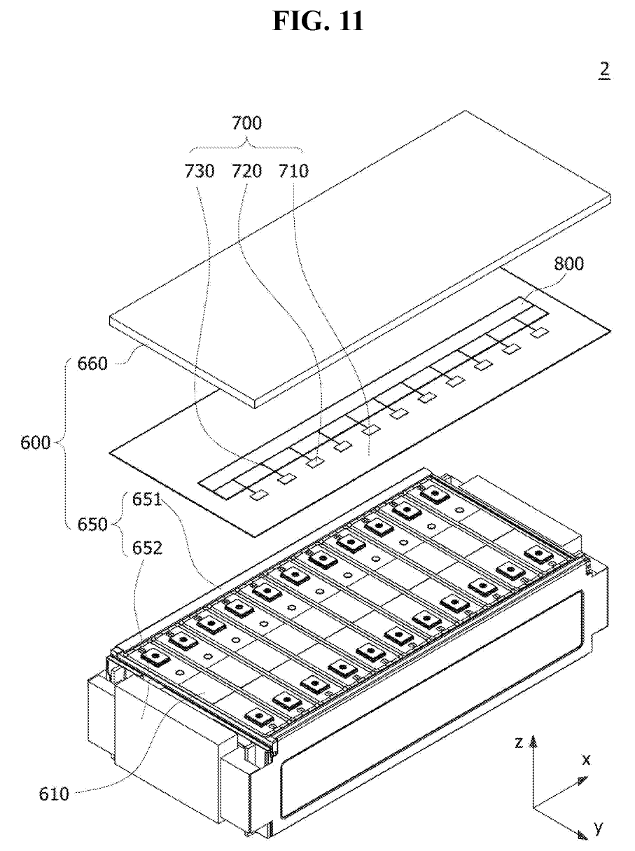

FIG. 11 is a schematic view illustrating a battery module according to another embodiment of the present disclosure. Referring to FIG. 11, a battery module 2 according to another embodiment of the present disclosure includes a case 600, a control unit 700, and a heat blocking unit 800.

A plurality of battery cells 610 may be embedded (e.g., accommodated) in the case 600. The case 600 may include a case body 650 that has an open upper side and is capable of accommodating the plurality of battery cells 610, and a case cover 660 that covers an open area of the case body 650.

The battery cell 610 may function as a unit structure that stores and supplies electricity. The battery cell 610 may have an exterior with an angular hexahedral shape.

The case 600 may provide a space for accommodating the battery cells 610 in a line. The case body 650 may include first main body partition walls 651 covering the battery cells 610 disposed in a line in an x-axis direction, and second main body partition walls 652 connecting a pair of first main body partition walls 651 and disposed to face the battery cells 610.

The control unit 700 may be connected to the battery cell 610 to detect a state of the battery cell 610. This control unit 700 may manage each battery cell 610 and may manage each battery cell 610 embedded in the case 600.

The control unit 700 may be embedded in the case 600 and individually connected to the battery cell 610. The control unit 700 may include a detection device, a balancing device, and a control device.

The detection device may detect a state (voltage, current, temperature, or the like) of the battery cell 610 and detect state information indicating the state of the battery cell 610. The detection device may detect a voltage for each battery cell 610. The detection device may also detect a current for each battery cell 610. The detection device may also detect the battery cell 610 or an ambient temperature at at least one point of the case 600.

The balancing device may perform a balancing operation of the battery cells 610.

The control device may receive state information (voltage, current, temperature, or the like) of the battery cell 610 from the detection device. The control device may monitor and calculate a state (voltage, current, temperature, SOC, SOH, or the like) of the battery cell 610 based on the state information received from the detection device. In addition, the control device may perform a control function (for example, a temperature control, balancing control, or charge/discharge control function), a protection function (for example, an over-discharge, over-charge, or over-current prevention, short-circuit, or fire extinguishing function) based on state monitoring results. In addition, the control device may perform a wired or wireless communication function with an external device (for example, an upper controller, a vehicle, a charger, or a PCS). The control device may also control a charging/discharging operation and a protection operation of a battery.

The detection device, the balancing device, and the control device may each include a processor and a memory.

The processor may be implemented as a CPU or an SoC, may drive an operating system or application to control a plurality of hardware or software components connected to the processor, and may process various pieces of data and perform calculations. The processor may be configured to execute at least one instruction stored in the memory and store execution result data in the memory.

The memory may store at least one instruction executed by the processor. The memory may be implemented as a volatile storage medium and/or a non-volatile storage medium, for example, as a ROM and/or a RAM.

The heat blocking unit 800 may be provided in the control unit 700 and may prevent damage to the control unit 700 due to heat of the battery cell 610. The heat blocking unit 800 may be formed integrally with the control unit 700 or attached to the control unit 700. The heat blocking unit 800 may include an insulating material to block heat of the battery cell 610 from reaching components of the control unit 700.

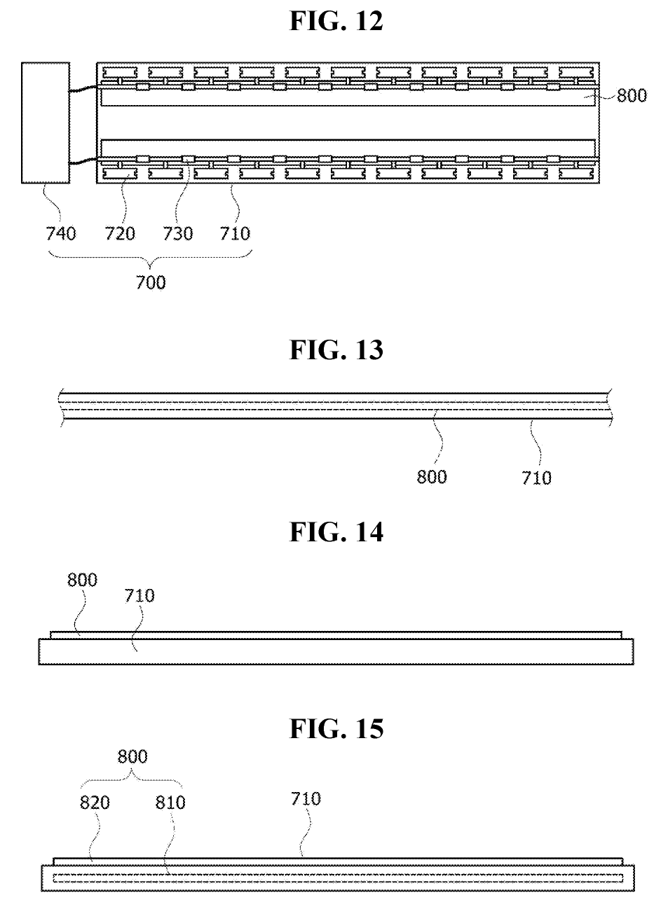

FIG. 12 is a plan view illustrating the control unit according to another embodiment of the present disclosure. Referring to FIG. 12, the control unit 700 according to another embodiment of the present disclosure may include an insulating plate 710, a busbar 720, a wire harness 730, and a control board 740.

The insulating plate 710 may be embedded in the case 600. The insulating plate 710 may be molded by including an insulating material and a flame retardant material. Inside the case 600, the battery cells 610 may be disposed in a line, and the insulating plate 710 may be disposed above the battery cells 610. The insulating plate 710 may be seated above the battery cell 610 or may be placed across an inner side of the case 600.

The insulating plate 710 may include at least one of PA6, PI, polysulfone, PU, PA, 6,6 nylon, PC, PTFE, PMMA, and PET.

A plurality of busbars 720 are mounted on an insulating plate 710 and may be connected to each battery cell 610. A lower portion of the busbar 720 may be connected to a terminal of the battery cell 610, and an upper portion of the busbar 720 may be exposed on the insulating plate 710. The busbar 720 may be coupled to the insulating plate 710 or exposed to the outside through a hole formed in the insulating plate 710.

The wire harness 730 may be mounted on the insulating plate 710 and connected to the busbar 720 to transmit a signal. The wire harness 730 may be disposed in a length direction of the insulating plate 710 and may include a plurality of cables connected to each busbar 720.

The control board 740 may be connected to the wire harness 730 and may control the battery cell 610. Components for controlling the battery cell 610 may be mounted on the control board 740. The control board 740 may be disposed inside the case 600 and may be disposed between the insulating plate 710 and the case cover 660.

In addition, the control board 740 may be formed integrally with the insulating plate 710. In this case, the heat blocking unit 800 may be disposed to protect the control board 740 by insulating the control board 740.

The heat blocking unit 800 according to one or more embodiments of the present disclosure may be formed on the insulating plate 710 and may be disposed between the battery cell 610 and the wire harness 730. The heat blocking unit 800 may prevent heat generated in the battery cell 610 from reaching the wire harness 730.

FIG. 13 is a schematic view illustrating a state in which the heat blocking unit according to another embodiment of the present disclosure is embedded in the insulating plate. Referring to FIG. 13, the heat blocking unit 800 according to a first embodiment may be embedded in the insulating plate 710.

The insulating plate 710 may be injection-molded using an insulating resin material, and the heat blocking unit 800 may be formed integrally with the insulating plate 710. In addition, a pair of insulating plates 710 may be assembled to face each other, and the heat blocking unit 800 may be disposed between the insulating plates 710.

FIG. 14 is a schematic view illustrating a state in which the heat blocking unit according to another embodiment of the present disclosure is attached to an upper surface of the insulating plate. Referring to FIG. 14, the heat blocking unit 800 according to the second embodiment may be attached to the insulating plate 710. The heat blocking unit 800 includes an insulating substrate, and the insulating substrate may include a tape layer.

The heat blocking unit 800 may be disposed between the insulating plate 710 and the wire harness 730. The heat blocking unit 800 may be attached to an upper surface of the insulating plate 710 to support the wire harness 730 (see FIG. 14). The heat blocking unit 800 may cover the wire harness 730. In addition, the heat blocking unit 800 may be attached to a lower surface of the insulating plate 710 as shown in FIG. 9 or may be attached to each of upper and lower surfaces of the insulating plate 710 as shown in FIG. 10.

FIG. 15 is a schematic view illustrating a state in which the heat blocking unit according to another embodiment of the present disclosure is embedded in the insulating plate and attached to the upper surface of the insulating plate. Referring to FIG. 15, the heat blocking unit 800 may include a first blocking unit 810 and a second blocking unit 820. The first blocking unit 810 may be embedded in the insulating plate 710, and the second blocking unit 820 may be attached to an upper surface of the insulating plate 710 to support the wire harness 730. In this case, the first blocking unit 810 may correspond to (e.g., may be) the heat blocking unit 800 shown in FIG. 13, and the second blocking unit 820 may correspond to the heat blocking unit 800 shown in FIG. 14.

The heat blocking unit 800 according to another embodiment of the present disclosure may include an insulating substrate, and the insulating substrate may include at least one of mica, fiber, sericite, talc, diatomaceous earth, bentonite, silicon, elvan, kaolin, PI, and polyethylene terephthalate.

The heat blocking unit 800 according to another embodiment of the present disclosure may include two insulating substrates and an insulating layer positioned between the two insulating substrates and including an insulating material.

The two insulating substrates may include at least one of mica, talc, diatomaceous earth, bentonite, silicon, elvan, kaolin, PI, and polyethylene terephthalate, or a mixture of two or more thereof.

The insulating material may include at least one of aerogel, wet silica, dry silica, PU, polystyrene, polyethylene, and polyester, or a mixture of two or more thereof.

A damage prevention structure of the control unit in the battery module according to another embodiment of the present disclosure having such a structure will be described as follows.

The insulating plate 710 is disposed above the battery cell 610, and the wire harness 730 is connected to the busbar 720 connected to the battery cell 610. The wire harness 730 is seated on the insulating plate 710, and the heat blocking unit 800 is formed on the insulating plate 710.

The heat blocking unit 800 may be embedded in the insulating plate 710 or optionally attached to an outer surface of the insulating plate 710. Since the heat blocking unit 800 is formed by including an insulating material, the heat blocking unit 800 can block heat from being transferred to the wire harness 730 even when the battery cell 610 is heated. The occurrence of a short circuiting of the wire harness 730 may be prevented by the heat blocking unit 800.

According to an energy storage system and a battery module according to an embodiment of the present disclosure, a control unit 400 or 700 can be connected to each of the plurality of battery cells 110 or 610 to transmit or receive an electrical signal, and a heat blocking unit 500 or 800 provided in the control unit 400 or 700 can prevent heat of the heated battery cell 110 or 610 from reaching the control unit 400 or 700 to damage components of the control unit 400 or 700.

According to the energy storage system and the battery module according to an embodiment of the present disclosure, the heat blocking unit 500 or 800 is embedded in an insulating plate 410 or 710, thereby blocking heat transfer of the plurality of battery cells 110 or 610.

According to the energy storage system and the battery module according to an embodiment of the present disclosure, the heat blocking unit 500 or 800 is attached to the insulating plate 410 or 710, thereby blocking heat transfer of the plurality of battery cells 110 or 610.

According to still another aspect of the present disclosure, there may be provided a vehicle including a battery module having an improved structure.

As the energy density of batteries continues to increase, an amount and ejection pressure of flames in vents of battery cells are increasing, which makes it difficult to early extinguish or suppress fires with general fire suppression equipment. In addition, even when a fire extinguishing agent is sprayed, since damage to wires or a short circuit occurs due to post-heating, the demand for an ESS extinguishing system for preventing secondary ignition is gradually increasing.

The present disclosure is directed to providing an energy storage system capable of preventing secondary ignition of a wire harness that transmits information of a battery cell, and a battery module.

Example embodiments have been disclosed herein, and although specific terms are employed, they are used and are to be interpreted in a generic and descriptive sense only and not for purpose of limitation.In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An energy storage system, comprising:
a battery module including a plurality of battery cells;
a battery rack configured to support the battery module;
a module fire extinguishing unit configured to detect whether a fire has occurred in the battery module and spray a fire extinguishing agent onto the battery module if fire is detected;
a control unit connected to the plurality of battery cells, the control unit being configured to detect a state of one or more of the plurality of battery cells; and
a heat blocking unit in the control unit and configured to prevent damage to at least one of the plurality of battery cells due to heat.

2. The energy storage system as claimed in claim 1, wherein the module fire extinguishing unit includes:
a module detection unit configured to detect at least one of a temperature change and a size change of the battery module; and
a module spray unit configured to spray the fire extinguishing agent onto the battery module according to a detection signal of the module detection unit.

3. The energy storage system as claimed in claim 2, wherein the module detection unit includes at least one of a temperature sensor configured to detect a temperature of the battery module, and a size sensor configured to detect a size of the battery module.

4. The energy storage system as claimed in claim 3, wherein the temperature sensor measures a temperature of each of the plurality of battery cells in the battery module.

5. The energy storage system as claimed in claim 3, wherein the size sensor is on the battery rack, the size sensor photographing the size of the battery module.

6. The energy storage system as claimed in claim 3, further comprising a housing including the battery rack, wherein the size sensor is on the housing, the size sensor photographing the size of the battery rack.

7. The energy storage system as claimed in claim 2, wherein the module spray unit includes:
a fire extinguishing tank in which the fire extinguishing agent is stored;
a fire extinguishing pipe connected to the fire extinguishing tank, the fire extinguishing pipe being configured to guide the fire extinguishing agent; and
a fire extinguishing nozzle on the fire extinguishing pipe, the fire extinguishing nozzle being configured to spray the fire extinguishing agent onto the battery module.

8. The energy storage system as claimed in claim 1, wherein the control unit includes:
an insulating plate in the battery module;
a busbar on the insulating plate, the busbar being connected to the plurality of battery cells;
a wire harness on the insulating plate, the wire harness being connected to the busbar to transmit a signal; and
a control board connected to the wire harness, the control board being configured to control the plurality of battery cells.

9. The energy storage system as claimed in claim 8, wherein the heat blocking unit is on the insulating plate, the heat blocking unit being between the plurality of battery cells and the wire harness to prevent heat generated in the plurality of battery cells from reaching the wire harness.

10. The energy storage system as claimed in claim 9, wherein the heat blocking unit is in the insulating plate.

11. The energy storage system as claimed in claim 10, wherein the heat blocking unit is integral with the insulating plate.

12. The energy storage system as claimed in claim 9, wherein the heat blocking unit is attached to the insulating plate.

13. The energy storage system as claimed in claim 12, wherein the heat blocking unit is between the insulating plate and the wire harness.

14. The energy storage system as claimed in claim 1, wherein:
the heat blocking unit includes insulating substrates, and
the insulating substrates are each made of at least one of mica, fiber, sericite, talc, diatomaceous earth, bentonite, silicon, elvan, kaolin, polyimide, and polyethylene terephthalate.

15. The energy storage system as claimed in claim 14, wherein the heat blocking unit includes:
two insulating substrates of the insulating substrates; and
an insulating layer between the two insulating substrates, the insulating layer including an insulating material.

16. The energy storage system as claimed in claim 15, wherein the insulating material is at least one of aerogel, wet silica, dry silica, polyurethane, polystyrene, polyethylene, and polyester.

17. A battery module, comprising:
a case having a plurality of battery cells therein;
a control unit connected to the plurality of battery cells, the control unit being configured to detect a state of the plurality of battery cells; and
a heat blocking unit in the control unit, the heat blocking unit being configured to prevent damage to the plurality of battery cells due to heat.

18. The battery module as claimed in claim 17, wherein the control unit includes:
an insulating plate in the case;
a busbar on the insulating plate, the busbar being connected to the plurality of battery cells;
a wire harness on the insulating plate, the wire harness being connected to the busbar to transmit a signal; and
a control board connected to the wire harness, the control board being configured to control the plurality of battery cells.

19. The battery module as claimed in claim 18, wherein the heat blocking unit is in the insulating plate, the heat blocking unit being between the plurality of battery cells and the wire harness to prevent heat generated in the plurality of battery cells from reaching the wire harness.

20. The battery module as claimed in claim 18, wherein the heat blocking unit is attached to the insulating plate, the heat blocking unit being between the insulating plate and the wire harness to prevent heat generated in the plurality of battery cells from reaching the wire harness.
